(19) United States
(12) Patent Application Publication
(10) Pub. No.: US 2026/0230571 A1
(43) Pub. Date: Aug. 6, 2026

(54) IMAGE FORMING APPARATUS, IMAGE PROCESSING APPARATUS, AND IMAGE PROCESSING SYSTEM

(71) Applicant: Hiroaki Morita, Mishima Shizuoka (JP)

(72) Inventor: Hiroaki Morita, Mishima Shizuoka (JP)

(73) Assignee: ETRIA CO., LTD., Kanagawa (JP)

(21) Appl. No.: 19/267,623

(22) Filed: Jul. 13, 2025

(30) Foreign Application Priority Data
Feb. 4, 2025 (JP) 2025-016810

(51) Int. Cl. H04N 1/00; H04N 1/21

(52) U.S. Cl. CPC H04N 1/0097; H04N 1/2162; H04N 2201/0094; H04N 2201/3202; H04N 2201/3271

(57) ABSTRACT

An image forming apparatus according to an embodiment includes: a print controller configured to print an image based on a print job; a generator configured to generate history information related to the printing of the image and containing apparatus identification information; and a communication interface configured to transmit the history information to an image processing apparatus capable of output the history information.

### CROSS-REFERENCE TO RELATED APPLICATION

This application is based upon and claims the benefit of priority from Japanese Patent Application No. 2025-016810, filed Feb. 4, 2025, the entire contents of which are incorporated herein by reference.

### FIELD

An embodiment described herein relates to, for example, an image forming apparatus configured to print a barcode, etc. on an elongated label sheet, an image processing apparatus connected to a plurality of image forming apparatuses via a network, and an image processing system in which an image processing apparatus is paired with a plurality of image forming apparatuses.

### BACKGROUND

Conventionally, an information processing system capable of performing unified management of label issuance histories for each label issuer who is permitted to issue a label is known as a system for managing a plurality of label printers.

In an information processing system with a plurality of label printers, there is a demand, for example, to output a list of label issuance histories for each label printer, and to reprint labels that have already been issued.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a block diagram showing an image processing system according to an embodiment.

FIG. 2 is an external perspective view showing an image forming apparatus of the image processing system shown in FIG. 1.

FIG. 3 is a cross-sectional schematic diagram showing an interior structure of the image forming apparatus shown in FIG. 2.

FIG. 4 is a block diagram showing a control system of the image forming apparatus shown in FIG. 2.

FIG. 5 is a schematic view showing an image processing apparatus of the image processing system shown in FIG. 1.

FIG. 6 is a schematic view showing a main part of the image processing apparatus shown in FIG. 5.

FIG. 7 is a block diagram showing a control system of the image processing apparatus shown in FIG. 5.

FIG. 8 is a block diagram showing a module of the processor shown in FIG. 7.

FIG. 9 is a diagram showing an example of a data structure of management information managed by a management unit shown in FIG. 8.

FIG. 10 is a diagram showing an example of a label image printed by the image forming apparatus shown in FIG. 2.

FIG. 11 is a flowchart illustrating an operation example of the image processing system shown in FIG. 1.

FIG. 12 is a flowchart illustrating an operation example of the image processing system shown in FIG. 1.

### DETAILED DESCRIPTION

An image forming apparatus according to an embodiment includes: a print controller configured to print an image based on a print job; a generator configured to generate history information related to the printing of the image and containing apparatus identification information; and a communication interface configured to transmit the history information to an image processing apparatus capable of output the history information.

Hereinafter, an embodiment will be described with reference to the drawings.

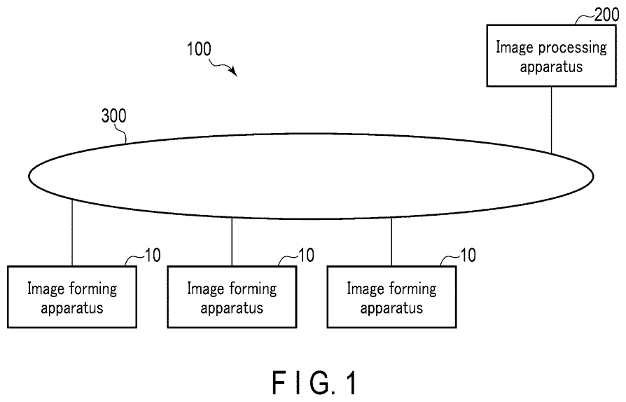

As shown in FIG. 1, an image processing system 100 according to an embodiment includes a plurality of image forming apparatuses 10 and an image processing apparatus 200. There may be more than one image processing apparatuses 200. The plurality of image forming apparatuses 10 and the image processing apparatus 200 are connected via a network 300. The image forming apparatus 10 is, for example, a label printer configured to print an image on an elongated label sheet. The image processing apparatus 200 is, for example, a multi-function peripheral (MFP) equipped with a printing function, a scanning function, a facsimile function, and the like. The image forming apparatus 10 may be an MFP similar to the image processing apparatus 200. A computer terminal, for example, may be further connected to the network 300. The network 300 is, for example, a LAN, a WAN, an intranet, or the Internet.

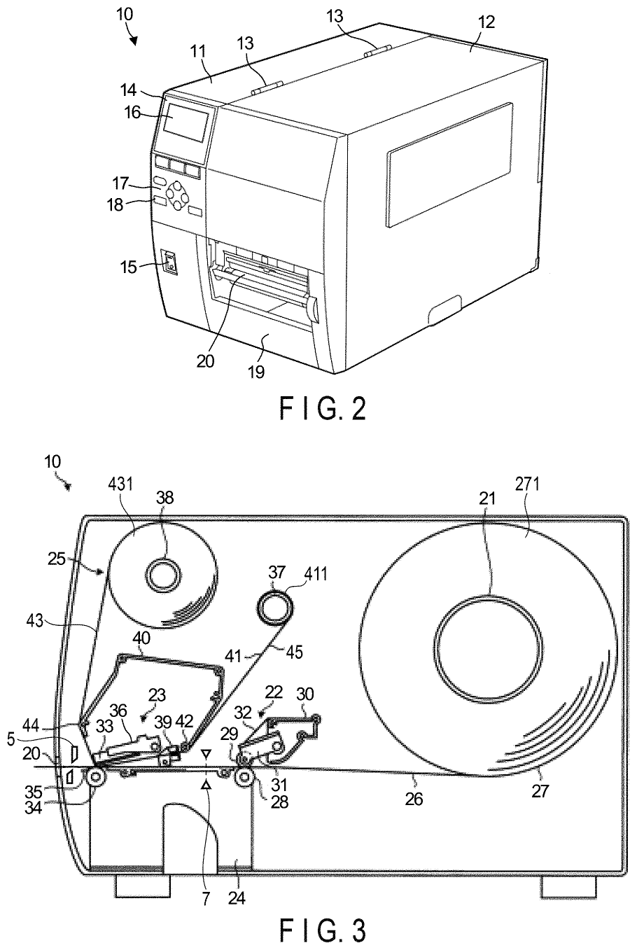

As shown in FIG. 2, the image forming apparatus 10 includes a substantially rectangular block-shaped housing that forms an outer shell of the apparatus. The housing includes a housing 11 at the left and a housing 12 at the right, as viewed from a side of an operation surface. The housing 12 at the right has a greater width than the housing 11 at the left. The two housings 11 and 12 are combined in such a manner that their opening portions overlap each other. Edge portions of the two housings 11 and 12 where their top plates face each other are joined by two hinges 13. By allowing the housing 12 at the right to pivot upward around the hinge 13, an interior space in the interior of the housings 11 and 12 can be opened wide.

The front panel 14 of the housing 11 at the left includes a power-supply switch 15, a display section 16, and an operation section 17. The operation section 17 includes a plurality of operation buttons 18. The front panel 19 of the housing 12 at the right includes a label issuance port 20 configured to issue a label on which an image is printed. The term “print” as used in the present embodiment and the claims include printing of character information, as well as printing of images such as drawing patterns and bar codes.

As shown in FIG. 3, a holding section 21 configured to hold a label roll 271, a conveying section 22 configured to convey a label sheet 27, a printing section 23 configured to print an image on a label, and a ribbon supplying section 25 are provided in the interior space of the housings 11 and 12 of the image forming apparatus 10. By allowing the housing 12 at the right to pivot around the hinges 13 to open the interior space, it is possible to attach a label roll 271 to the holding section 21, to replace ribbon rolls 411 and 431 in the ribbon supplying section 25, and to perform maintenance on mechanisms 21, 22, 23, and 25 of the image forming apparatus 10.

The holding section 21 rotatably holds a label roll 271 into which an elongated strip-shaped label sheet 27 is wound. The holding section 21 includes a shaft extending in a direction orthogonal to the plane of FIG. 3. The holding section 21 has a structure onto and from which the label roll 271 can be loaded and unloaded. By pulling the label sheet 27 to the left direction as viewed in FIG. 3, the label roll 271 rotates around the holding section 21 in a clockwise direction as viewed in FIG. 3.

Examples of the label sheet 27 include, for example, a peel-away type in which a plurality of labels are lined up and adhered to a surface of an elongated strip-shaped backing sheet, and a linerless type in which a plurality of labels are joined together, with no backing sheet, in the form of a strip. The linerless-type label sheet 27 includes, on its back surface, an adhesive layer, and includes, on its top surface, a release layer from which the adhesive layer can be released. The labels include a type formed of a non-thermosensitive material on which an ink of the ink ribbon 41 is heated and transferred to print an image thereon, and a type formed of a thermosensitive material that develops color when heated.

That is, label rolls 271 include a non-thermosensitive label roll 271 and a thermosensitive label roll 271. The non-thermosensitive label roll 271 is either a roll into which a peel-away-type label sheet 27 containing a plurality of non-thermosensitive labels adhered to an elongated backing sheet is wound, or a roll into which a linerless-type label sheet 27 containing a plurality of non-thermosensitive labels, with no backing sheet, is wound. On the other hand, the thermosensitive label roll 271 is either a roll into which a peel-away-type label sheet 27 containing a plurality of thermosensitive labels adhered to an elongated backing sheet is wound, or a roll into which a linerless-type label sheet 27 containing a plurality of thermosensitive labels, with no backing sheet, is wound.

The conveying section 22 includes a conveying roller 28, a pinch roller 29, frames 24 and 30, a supporting arm 31, a leaf spring 32, and a label sensor 7.

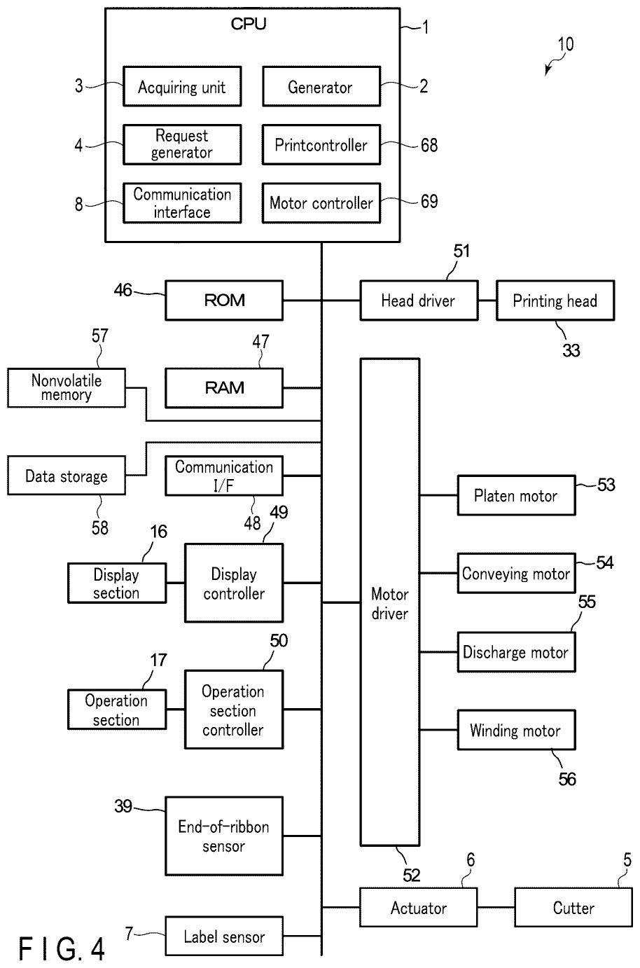

The conveying roller 28 includes a rotating shaft extending in the direction orthogonal to the plane of FIG. 3. The conveying section 22 includes a conveying path 26 on which the label sheet 27 pulled from the label roll 271 is conveyed in a substantially horizontal direction. The frame 24 is provided below the conveying path 26. The frame 24 rotatably supports the conveying roller 28 below the conveying path 26. The image forming apparatus 10 includes a conveying motor 54 (FIG. 4) configured to rotate the conveying roller 28.

The pinch roller 29 includes a rotating shaft extending in the direction orthogonal to the plane of FIG. 3. The pinch roller 29 is located above the conveying roller 28 so as to face the conveying roller 28, with the conveying path 26 sandwiched in between. A pinch roller 29 is rotatably attached to a distal end of the supporting arm 31 in a pivoting direction. The frame 30 is provided above the conveying path 26. A proximal portion of the supporting arm 31 is pivotally attached to the frame 30. The leaf spring 32 is attached between the frame 30 and the supporting arm 31, and generates a restoring force in a direction that presses the pinch roller 29 against the conveying roller 28.

The label sensor 7 is, for example, a transmissive sensor including a light-emitting part and a light-receiving part, with the conveying path 26 of the label sheet 27 sandwiched in between. The label sensor 7 is located on the conveying path 26 between the conveying roller 28 and the printing section 23. The label sensor 7 is configured to detect light that is transmitted through the label sheet 27, and to output a signal in which an increase/decrease in the amount of the transmitted light is reflected in accordance with conveyance of the label sheet 27. More specifically, the label sensor 7 emits light from the light-emitting part toward the label sheet 27, receives the light transmitted through the label sheet 27 at the light-receiving part, and outputs an electric signal that changes in accordance with the amount of the received light (transmitted light).

If the conveying roller 28 is rotated by the conveying motor 54, the label sheet 27 sandwiched between the conveying roller 28 and the pinch roller 29 receives a conveying force from the conveying roller 28, and is conveyed along the conveying path 26, allowing the label sheet 27 to be pulled from the label roll 271. At this time, the image forming apparatus 10 detects a front end or a rear end of each label in a conveying direction based on a signal output from the label sensor 7, and rotates and stops the conveying motor 54 based on a result of the detection, thereby conveying (feeding) the label on which printing is to be performed to a printing position.

The conveying path 26 of the label sheet 27 starts at a point where the label sheet 27 is pulled from the label roll 271 attached to the holding section 21. The conveying path 26 passes through a position where the pinch roller 29 and the conveying roller 28 meet in the conveying section 22. The conveying path 26 passes through a position where a printing head 33 and a platen roller 34 of the printing section 23 meet. The conveying path 26 terminates at the label issuance port 20. In the case of using a peel-away-type label sheet in which a plurality of labels are adhered to a backing sheet, only the labels peeled away from the backing sheet can be issued from the label issuance port 20.

The printing section 23 includes a printing head 33, a platen roller 34, and a holding arm 36.

The platen roller 34 includes a rotating shaft extending in the direction orthogonal to the plane of FIG. 3. The frame 24 of the conveying section 22 provided below the conveying path 26 rotatably supports the platen roller 34 below the conveying path 26. The image forming apparatus 10 includes a platen motor 53 (FIG. 4) configured to rotate the platen roller 34. The platen roller 34 and the platen motor 53 function as part of the conveying section 22 configured to convey the label sheet 27.

The printing head 33 is located above the platen roller 34 so as to face the platen roller 34, with the conveying path 26 sandwiched in between. The printing head 33 is, for example, a thermal head including a plurality of heat-generating bodies arranged in the direction orthogonal to the plane of FIG. 3. The ink ribbon 41 and the label sheet 27 pass through the conveying path 26 between the platen roller 34 and the printing head 33 in a vertically overlapping state.

The holding arm 36 is arranged above the conveying path 26, and includes a printing head 33 at a distal end in a swinging direction. The frame 40 of the ribbon supplying section 25 arranged above the conveying path 26 pivotally supports a proximal portion of the holding arm 36 in the swinging direction. By swinging the holding arm 36 relative to the frame 40, it is possible to move the printing head 33 toward and away from the platen roller 34.

The ribbon supplying section 25 is provided above the conveying path 26. The ribbon supplying section 25 includes a discharge shaft 37, a winding shaft 38, an end-of-ribbon sensor 39, and a frame 40.

The discharge shaft 37 is a shaft extending in a direction orthogonal to the plane of FIG. 3, and is configured to detachably hold a ribbon roll 411 into which an unused ink ribbon 41 is wound. By rotating the discharge shaft 37 in a clockwise direction as viewed in FIG. 3, the ink ribbon 41 is discharged from the ribbon roll 411.

The frame 40 includes a guide roller 42 around which the ink ribbon 41 discharged from the ribbon roll 411 is wound for guiding. The guide roller 42 includes a rotating shaft configured to extend in a direction orthogonal to the plane of FIG. 3, and is attached to the frame 40 so as to be freely rotatable.

The winding shaft 38 is a shaft extending in the direction orthogonal to the plane of FIG. 3, and is configured to detachably hold a ribbon roll 431 into which a used ink ribbon 43 that has passed through the printing head 33 is wound. In the case of winding a used ink ribbon 43, the winding shaft 38 is rotated in the clockwise direction in FIG. 3.

A guide roller 44, around which a used ink ribbon 43 is wound for guiding, is provided between the printing head 33 and the winding shaft 38. The guide roller 44 includes a rotating shaft extending in a direction orthogonal to the plane of FIG. 3, and is attached to the frame 40 so as to be freely rotatable.

The image forming apparatus 10 includes a discharge motor 55 for rotating the discharge shaft 37 (FIG. 4) and a winding motor 56 for rotating the winding shaft 38 (FIG. 4). By driving the discharge motor 55 and the winding motor 56, the ribbon supplying section 25 supplies the ink ribbon 41 along the conveying path 26 of the label sheet 27 and winds up the used ink ribbon 43. The ink ribbon 41 passes through the platen roller 34 and the printing head 33, while being overlapped on top of the label sheet 27.

The conveying path 45 of the ink ribbons 41 and 43 starts at the point where the ink ribbon 41 is discharged from the ribbon roll 411 attached to the shaft 37. The conveying path 45 passes through the position contacting the guide roller 42, and passes through the end-of-ribbon sensor 39 and the printing head 33. The conveying path 45 passes through the guide roller 44, and terminates at a point where the ink ribbon 41 is wound up by the winding shaft 38.

The end-of-ribbon sensor 39 detects a termination of the ink ribbon 41. The end-of-ribbon sensor 39 is provided between the printing section 23 and the discharge shaft 37 configured to discharge the ink ribbon 41. The end-of-ribbon sensor 39 is, for example, a reflective sensor including a light-emitting element and a light-receiving element. Alternatively, the end-of-ribbon sensor 39 may be a transmissive sensor, or a sensor configured to mechanically detect a termination of the ink ribbon 41.

Other than the above, the image forming apparatus 10 includes a label peel plate 35 at a position adjacent to the conveying path 26 on a downstream side of the printing section 23. In the case of using a peel-away-type label sheet in which a plurality of labels are adhered to a backing sheet, the label can be peeled away from the backing sheet with the label peel plate 35. The backing sheet from which the label has been peeled away can be wound up by a winding mechanism (not illustrated). In this case, the label sheet 27 is wound around the platen roller 34 to be bent, and the label is peeled away from the backing sheet with the label peel plate 35 arranged outside the bending position. The label is issued from the label issuing port 20 after being peeled away from the backing sheet.

Also, the image forming apparatus 10 includes, on an upstream side of the label issuance port 20, a cutter 5 configured to cut an elongated linerless-type label sheet 27 into a plurality of labels. In the case of using a linerless-type label sheet 27 in which a plurality of labels are joined together, with no backing sheet, in the form of a strip, the label sheet 27 is cut by the cutter 5 in front of the label issuance port 20. The labels individually cut by the cutter 5 are issued via the label issuance port 20.

In the case where an ink transfer print mode is executed in the above-described image forming apparatus 10 with a non-thermosensitive label roll 271 loaded on the holding section 21, the conveying section 22 pulls the label sheet 27 from the label roll 271, and is conveyed along the conveying path 26. In this case, the ribbon supplying section 25 supplies the ink ribbon 41 over the label sheet 27, the printing head 33 transfers the ink of the ink ribbon 41 on one or more labels of the label sheet 27 onto which a target image is to be printed, and prints the target image onto each label of the label sheet 27. In the case where a thermosensitive print mode is executed in the above-described image forming apparatus 10 with a thermosensitive label roll 271 loaded on the holding section 21, the conveying section 22 pulls the label sheet 27 from the label roll 271, and is conveyed along the conveying path 26. In this case, the printing head 33 causes a thermosensitive layer of one or more labels of the label sheet 27 onto which a target image is to be printed to develop color, and print the target image onto each label of the label sheet 27.

As shown in FIG. 4, the image forming apparatus 10 includes a central processing unit (CPU) 1, a read-only memory (ROM) 46, a random-access memory (RAM) 47, a nonvolatile memory 57, and a data storage 58. The CPU 1 is connected to the communication interface 48, the display controller 49, the operation section controller 50, the head driver 51, the motor driver 52, the label sensor 7, the end-of-ribbon sensor 39, and the actuator 6, in addition to the ROM 46, the RAM 47, the nonvolatile memory 57, and the data storage 58, via buses and interfaces. Note that an “interface” is abbreviated as “I/F” in FIG. 4.

The ROM 46 stores programs to be executed by the image forming apparatus 10, as well as various data. The RAM 47 is an expansion memory configured to temporarily store the programs and data for the CPU 1 to execute the programs. The nonvolatile memory 57 is configured to store history information, etc. related to printing of a print job. The data storage 58 is configured to store printed data, etc. The communication interface 48 connects the image forming apparatus 10 to the network 300, to allow data communication between the image forming apparatus 10 and the image processing apparatus 200 (or a computer terminal). The image processing apparatus 200 is capable of transmitting the printed data (or a print job) to the RAM 47 via the communication interface 48. The printed data and the print job may be either input via the operation section 17, or via a computer terminal. The communication interface 48 is compatible with, for example, USB, RS-232C, RAN, or the like.

The display controller 49 controls display of information such as images and characters in the display section 16. The operation section controller 50 receives an input of various information via the operation section 17. The head driver 51 controls driving of the printing head 33. The head driver 51 switchably turns on and off the heating body of the printing head 33 based on the printed data, and transfers image onto the label sheet 27. The actuator 6 drives the cutter 5.

The motor driver 52 performs drive control of the platen motor 53, the conveying motor 54, the discharge motor 55, and the winding motor 56. The platen motor 53 performs rotary drive of the platen roller 34 of the printing section 23. The conveying motor 54 performs rotary drive of the conveying roller 28 of the conveying section 22. The discharge motor 55 performs rotary drive of the discharge shaft 37 of the ribbon supplying section 25. The winding motor 56 performs rotary drive of the winding shaft 38 of the ribbon supplying section 25.

The programs executed by the image forming apparatus 10 are provided by being incorporated into the ROM 46, etc. The programs executed by the image forming apparatus 10 according to the present embodiment may be configured to be provided by being recorded on a computer-readable storage medium, such as a CD-ROM, a flexible disc (FD), a CD-R, a digital versatile disk (DVD), etc., in an installable or executable format. In addition, the programs executed by the image forming apparatus 10 according to the present embodiment may be configured to be provided by being stored on a computer connected to a network, such as the Internet, so as to be downloaded via a network. In addition, the programs executed by the image forming apparatus 10 according to the present embodiment may be configured to be provided or distributed via a network such as the Internet.

The CPU (processor) 1 includes a generator 2, an acquiring unit 3, a request generator 4, a communication interface 8, a print controller 68, and a motor controller 69, as shown in FIG. 4. The CPU 1 loads the programs of the storage medium such as the ROM 46 onto a primary storage (e.g., the RAM 47) and executes the programs, thereby realizing the functions of the generator 2, the acquiring unit 3, the request generator 4, the communication interface 8, the print controller 68, the motor controller 69, etc. Hereinafter, the function of each of the units 2, 3, 4, 8, 68, and 69 of the CPU 1 will be described.

The generator 2 generates printing-related history information containing apparatus identification information (a printer ID) for specifying the image forming apparatus 10. The apparatus identification information is, for example, an IP address assigned to each image forming apparatus 10. The apparatus identification information may be any information by which the image forming apparatus 10 can be specified. The history information contains, in addition to the apparatus identification information, information related to the print job, such as printed data related to characters and images actually printed on the labels, a date and time of printing of images based on the printed data, and the number of copies printed.

The history information may further contain information indicating that printing has been performed on the labels by the image forming apparatus 10, image information related to the printed images themselves, or the print jobs themselves. The image information may contain, for example, at least one of image information (first image information) related to an article to which a label with an image printed thereon is to be adhered and image information (second image information) related to delivery of an article to which the label has been adhered.

The acquiring unit 3 acquires identification information (hereinafter referred to as “label identification information”) of a label on which an image is to be printed. The acquiring unit 3 acquires, for example, label identification information issued by the image processing apparatus 200 in response to a request signal (issue request) transmitted from the image forming apparatus 10, and transmitted to the image forming apparatus 10. Alternatively, the acquiring unit 3 acquires label identification information issued by the image forming apparatus 10 based on an issue request input via the operation section 17. Alternatively, the acquiring unit 3 acquires label identification information input via a computer terminal. In the case where the image forming apparatus 10 issues label identification information, or label identification information is transmitted from a computer terminal, the image forming apparatus 10 transmits, to the image processing apparatus 200, the label identification information acquired by the acquiring unit 3 together with identification information (hereinafter referred to as “apparatus identification information”) such as a printer ID for specifying the image forming apparatus.

The request generator 4 outputs a request signal for requesting the image processing apparatus 200 to issue the label identification information.

Every time an image is printed on a label, the communication interface 8 transmits history information related to the print job to the image processing apparatus 200. The communication interface 8 transmits the request signal output from the request generator 4 to the image processing apparatus 200 together with the apparatus identification information of the image forming apparatus 10. The communication interface 8 receives label identification information issued by the image processing apparatus 200 in response to the request signal.

If, for example, printed data is input to the print controller 68 via the communication interface 48 or the operation section controller 50 in response to an input of an ink transfer print mode accepted at the operation section 17, the print controller 68 controls the operation of the printing head 33 via the head driver 51. The printing head 33 transfers an ink of the ink ribbon 41 on a label sheet 27 pulled from a non-thermosensitive label roll 271 that has been loaded, and prints an image based on the printed data.

If printed data is input to the print controller 68 via the communication interface 48 or the operation section controller 50 in response to an input of a thermosensitive print mode accepted at the operation section 17, the print controller 68 controls the operation of the printing head 33 via the head driver 51. The printing head 33 develops color of a thermosensitive layer of the label sheet 27 pulled from a non-thermosensitive label roll 271 that has been loaded, and prints an image based on the printed data.

The print controller 68 configured to print an image on a label based on a print job. The print controller 68 prints a target image based on the print job and the label identification information. The label identification information is, for example, a quick response (QR) code.

The motor controller 69 controls, via the motor driver 52, the rotary drive of the platen motor 53, the conveying motor 54, the discharge motor 55, and the winding motor 56, which are required to print an image on a label sheet 27 based on print data.

Note that some of the functions realized by execution of the programs by the CPU 1 may be realized by hardware circuitry such as an application-specific integrated circuit (ASIC), a digital signal processor (DSP), a field-programmable gate array (FPGA), or a graphics processing unit (GPU). In this case, the CPU 1 controls the functions executed by the hardware circuitry.

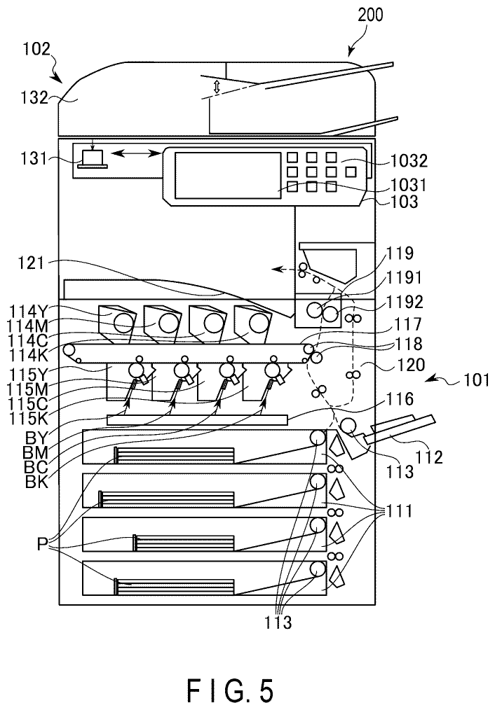

As shown in FIG. 5, the image processing apparatus 200 includes a printer 101, a scanner 102, and an operation panel 103. The printer 101 is equipped with a function of printing an image on a paper sheet P. The printer 101 includes a paper feed tray 111, a manual feed tray 112, a paper feed roller 113, a toner cartridge 114, an image forming unit 115, an optical scanning device 116, a transfer belt 117, a secondary transfer roller 118, a stabilizing section 119, a double-side unit 120, and a catch tray 121.

The paper feed tray 111 contains paper sheets P used for printing. The manual feed tray 112 is designed to contain paper sheets P to be manually fed. The paper feed roller 113 rotates to discharge the paper sheets P contained in the paper feed tray 111 or the manual feed tray 112 from the feed tray 111 or the manual feed tray 112.

The toner cartridge 114 contains a developer to be supplied to the image forming unit 115. The image processing apparatus 200 includes, for example, a toner cartridge 114C, a toner cartridge 114M, a toner cartridge 114Y, and a toner cartridge 114K. The toner cartridges 114C, 114M, 114Y, and 114K contain developers corresponding to the respective colors of cyan, magenta, yellow and key (CMYK). That is, the toner cartridge 114C contains a developer of cyan (C). The toner cartridge 114M contains a developer of magenta (M). The toner cartridge 114Y contains a developer of yellow (Y). The toner cartridge 114K contains a developer of black (K). The colors of the developers contained in the toner cartridge 114 are not limited to the CMYK colors, and may be other colors. The developers contained in the toner cartridge 114 may be, for example, color-erasable developers that lose their colors and become invisible at a temperature higher than a predetermined temperature.

The image processing apparatus 200 includes, for example, four image forming units 115C, 115M, 115Y, and 115K corresponding to the respective CMYK colors. The image forming units 115C, 115M, 115Y, and 115K, which have substantially the same structures, may be collectively referred to as an image forming unit 115. Each of the image forming unit 115C, the image forming unit 115M, the image forming unit 115Y, and the image forming unit 115K forms an image using developers corresponding to the respective CMYK colors. That is, the image forming unit 115C forms a cyan image. The image forming unit 115M forms a magenta image. The image forming unit 115Y forms a yellow image. The image forming unit 115K forms a black image.

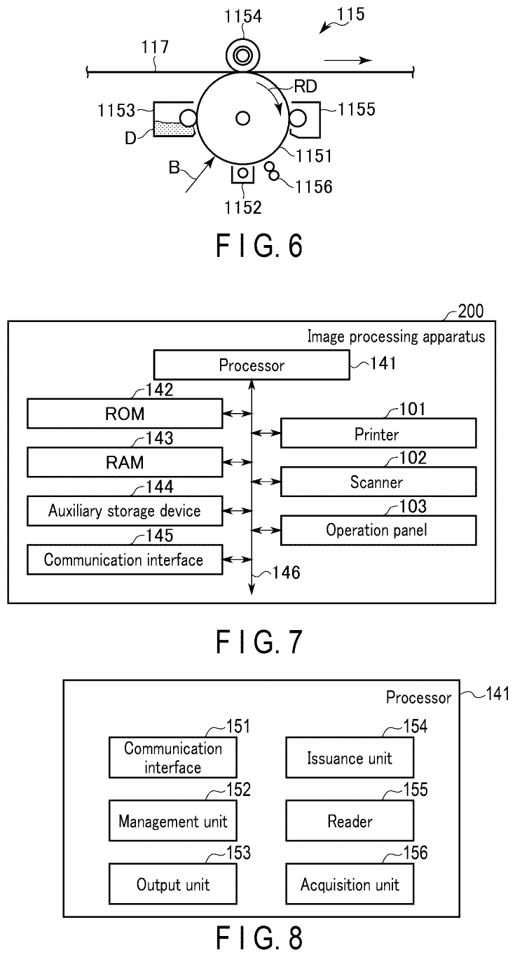

Details of the image forming unit 115 will be described with reference to FIG. 6. The image forming unit 115 includes, for example, a photoconductive drum 1151, a charging unit 1152, a development unit 1153, a primary transfer roller 1154, a cleaner 1155, and a neutralization lamp 1156.

A beam B emitted from the optical scanning device 116 is applied onto the photoconductive drum 1151. Thereby, an electrostatic latent image is formed on a surface of the photoconductive drum 1151.

The charging unit 1152 applies a predetermined amount of positive charge onto a surface of the photoconductive drum 1151.

The development unit 1153 develops the electrostatic latent image on the surface of the photoconductive drum 1151 using a developer D supplied from the toner cartridge 114. Thereby, an image by the developer D is formed on the surface of the photoconductive drum 1151.

The primary transfer roller 1154 is positioned to face the photoconductive drum 1151 with the transfer belt 117 sandwiched in between. The primary transfer roller 1154 causes a transfer voltage to be generated between the primary transfer roller 1154 and the photoconductive drum 1151. Thereby, the primary transfer roller 1154 transfers the image formed on a surface of the photoconductive drum 1151 onto the transfer belt 117 that is in contact with the photoconductive drum 1151 (primary transfer).

The cleaner 1155 removes the developing agent D remaining on the surface of the photoconductive drum 1151.

The neutralization lamp 1156 removes the charge remaining on the surface of the photoconductive drum 1151.

The optical scanning device 116 is also referred to as a laser scanning unit (LSU). The optical scanning device 116 forms an electrostatic latent image on the surface of the photoconductive drum 1151 of each image forming unit 115 by controlling the beam B in accordance with the input image data, under the control of the processor 141 (FIG. 7). The input image data is, for example, image data read by a scanner 102 from a document, etc. Alternatively, the input image data may be image data transmitted from another device such as the image forming apparatus 10, and received by the image processing apparatus 200.

It is assumed herein that a beam B emitted by the optical scanning device 116 to the image forming unit 115Y is a beam BY, that a beam B emitted to the image forming unit 115M is a beam BM, that a beam B emitted to the image forming unit 115C is a beam BC, and that a beam B emitted to the image forming unit 115K is a beam BK. The optical scanning device 116 controls the beam BY in accordance with a yellow (Y) component of the image data. The optical scanning device 116 controls the beam BM in accordance with a magenta (M) component of the image data. The optical scanning device 116 controls the beam BC in accordance with a cyan (C) component of the image data. The optical scanning device 116 controls the beam BK in accordance with a key (K) component of the image data.

The transfer belt 117 is, for example, an endless belt. The transfer belt 117 rotates to convey the image transferred from each of the image forming units 115 of the respective colors to the position of the secondary transfer roller 108.

The secondary transfer roller 108 includes two rollers that face each other. The secondary transfer roller 108 transfers the images formed on the transfer belt 117 onto a paper sheet P passing between the two rollers of the secondary transfer roller 108 (secondary transfer).

The stabilizing section 119 heats and pressurizes the paper sheet P on which images of the respective colors are transferred in an overlapping manner. Thereby, the images transferred onto the paper sheet P are stabilized. The stabilizing section 119 includes a heating roller 1191 and a pressurizing roller 1192, which face each other.

The heating roller 1191 includes a heat source. The heat source is, for example, a heater. The heating roller 1191 heated by the heat source allows its surface to be in contact with the paper sheet P, thereby heating the paper sheet P.

The pressurizing roller 1192 pressurizes the paper sheet P passing between the pressurizing roller 1192 and the heating roller 1191.

The double-side unit 120 allows a back surface of the paper sheet P to be in a printable state. For example, the double-side unit 120 switches back the paper sheet P using a roller, etc., thereby reversing the paper sheet P.

The catch tray 121 holds paper sheets P that have been ejected after completion of printing.

The scanner 102 is based on, for example, a reduced optical system including an imaging device such as a charge-coupled device (CCD) image sensor. Alternatively, the scanner 102 may be based on a contact image sensor (CIS) system including an imaging device such as a complementary metal-oxide-semiconductor (CMOS) image sensor. Alternatively, the scanner 102 may be based on any other known system. The scanner 102 reads an image from a document, etc. The scanner 102 includes a reading module 131 and a document feeder 132.

The reading module 131 converts incident light into a digital signal with an image sensor. Thereby, the reading module 131 reads an image from a surface of the document.

The document feeder 132 is also referred to as, for example, an automatic document feeder (ADF). The document feeder 132 sequentially conveys documents placed on a document tray. Images are read from the conveyed documents by the scanner 102. Also, the document feeder 132 may include a scanner for reading an image from a back surface of the document.

The operation panel 103 includes a human-machine interface that allows information to be input and output between the image processing apparatus 200 and an operator. The operation panel 103 is, for example, a touch panel 1031, an input device 1032, etc.

The touch panel 1031 is, for example, a stack of a display such as a liquid crystal display or an organic EL display and a pointing device to which a touch input can be made. A display included in the touch panel 1031 functions as a display device configured to display an image for notifying an operator of the image processing apparatus 200 of a variety of information. Also, the touch panel 1031 functions as an input device configured to accept a touch operation by an operator.

The input device 1032 accepts an operation by an operator of the image processing apparatus 200. The input device 1032 is, for example, a keyboard, a keypad, or a touchpad.

Next, a control system of the image processing apparatus 200 will be described with reference to FIGS. 7 and 8.

As shown in FIG. 7, the image processing apparatus 200 includes, for example, a processor 141, a read-only memory (ROM)122, a random-access memory (RAM)123, an auxiliary storage device 144, a communication interface 145, a printer 101, a scanner 102, and an operation panel 103. These components are connected via, for example, a bus 146.

The processor 141 corresponds to the nerve center of the computer that performs processing necessary for operation of the image processing apparatus 200, such as computing and controlling. The processor 141 controls the components to realize the functions of the image processing apparatus 200 based on programs such as system software, application software, and firmware stored in the ROM 142 or the auxiliary storage device 144. Note that some or all of such programs may be embedded in the circuitry of the processor 141. The processor 141 is, for example, a central processing unit (CPU), a microprocessing unit (MPU), a system on a chip (SoC), a digital signal processor (DSP), a graphics processing unit (GPU), an application-specific integrated circuit (ASIC), a programmable logic device (PLD), or a field-programmable gate array (FPGA). Alternatively, the processor 141 is a combination of them.

The ROM 142 corresponds to a primary storage of the computer whose nerve center is the processor 141. The ROM 142 is a nonvolatile memory used solely for data reading. Of the above-noted programs, the ROM 142 stores firmware, etc. Also, the ROM 142 stores various setting values or data used by the processor 141 in performing various processes.

The RAM 143 corresponds to a primary storage of the computer whose nerve center is the processor 141. The RAM 143 is a memory used for data reading and writing. The RAM 143 is employed as a working area where data to be temporarily used by the processor 141 in performing various processes is stored. The RAM 143 is, for example, a volatile memory.

The auxiliary storage device 144 corresponds to the auxiliary storage of the computer whose nerve center is the processor 141. The auxiliary storage device 144 is, for example, an electrically erasable programmable read-only memory (EEPROM), a hard disk drive (HDD), a solid state drive (SSD), or an embedded multimedia card (eMMC). Of the above-noted programs, the auxiliary storage device 144 stores, for example, system software, application software, and the like. Also, the auxiliary storage device 144 stores data to be used by the processor 141 in performing various processes, data generated by processing at the processor 141, and/or various setting values. Note that the image processing apparatus 200 may include, as the auxiliary storage device 144, an interface into which a storage medium such as a memory card or a universal serial bus (USB) memory can be inserted. The interface allows information to be read and written from and to the storage medium.

The communication interface 145 is an interface for the image processing apparatus 200 to communicate with the image forming apparatus 10 via the network 300.

The bus 146 includes a control bus, an address bus, a data bus, etc., and transfers signals transmitted and received between the components of the image processing apparatus 200.

As shown in FIG. 8, the processor 141 includes modules such as a communication interface 151, a management unit 152, an output unit 153, an issuance unit 154, a reader 155, and an acquisition unit 156. The processor 141 loads the programs of the storage medium such as the ROM 142 onto a primary storage (e.g., the RAM 143) and executes the programs, thereby realizing the functions of the communication interface 151, the management unit 152, the output unit 153, the issuance unit 154, the reader 155, the acquisition unit 156, etc. Hereinafter, the function of each of the units 151, 152, 153, 154, 155, and 156 of the processor 141 will be described.

The communication interface 151 receives a print job, as described above, transmitted from each of the plurality of image forming apparatuses 10. The print job is transmitted from each of the image forming apparatuses 10, in association with apparatus identification information for specifying the image forming apparatus 10 that has transmitted the print job. The print job contains printed data, a date and time of printing, a number of copies printed, information related to the print job, and the like. The communication interface 151 receives, from the image forming apparatus 10, a request signal requesting issuance of identification information of a label on which an image is to be printed by the image forming apparatus 10, and returns label identification information issued in response to the request signal to the image forming apparatus 10 that has transmitted the request signal.

The management unit 152 collectively manages after-issuance print jobs transmitted from the plurality of image forming apparatuses 10. The print jobs transmitted from the plurality of image forming apparatuses 10 to the image processing apparatus 200 in association with the apparatus identification information are stored as, for example, management information in which history information of the plurality of image forming apparatuses 10 is gathered in the RAM 143, etc. The management unit 152 manages the history information for each image forming apparatus based on the apparatus identification information.

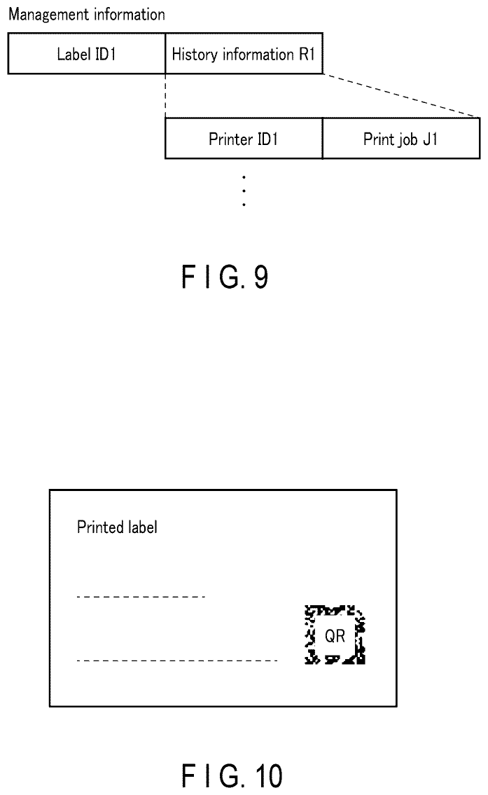

The output unit 153 outputs management information managed by the management unit 152. An example of a data configuration of the management information is shown in FIG. 9. The output unit 153 operates the printer 101 and prints, onto a paper sheet P, the management information containing the history information transmitted from the plurality of image forming apparatuses 10. Alternatively, the output unit 153 may be configured to display, via the operation panel 103, management information containing history information transmitted from the plurality of image forming apparatuses 10. Alternatively, the output unit 153 may be configured to transmit, to a computer terminal, management information managed by the management unit 152.

The issuance unit 154 issues, in response to a request signal (issuance request) received from a image forming apparatus 10 via the communication interface 151, identification information (a label ID) of a label on which an image is to be printed by the image forming apparatus 10. The communication interface 151 returns the label identification information issued by the issuance unit 154 to the image forming apparatus 10 that has transmitted the request signal.

The reader 155 reads the image printed on the label by the image forming apparatus 10. An example of the image printed on the label is shown in FIG. 10. The image on the label can be read by the scanner 102. In the case where the image processing apparatus 200 includes a barcode reader, the reader 155 can read label identification information (a QR code) with the barcode reader.

The processor 141 extracts, from the RAM 143, history information related to printing by the image forming apparatus 10 that has printed the label with the label identification information using the QR code read from the label as a key.

The acquisition unit 156 acquires a request signal requesting reprinting of the image read from the label issued by the image forming apparatus 10. If, for example, an input requesting reprinting of an image including a QR code read by the scanner 102 is made via the operation panel 103, the acquisition unit 156 acquires a request signal for reprinting. At this time, the processor 141 displays, for example, an image including a QR code read by the scanner 102 and a reprinting key via the operation panel 103.

If the communication interface 151 receives, via the operation panel 103, an instruction to change a transmission destination of a print job contained in the history information, the communication interface 151 is capable of transmitting the print job to an image forming apparatus 10 other than the image forming apparatuses 10 that has transmitted the request signal.

For the hardware of the image processing apparatus 200, an existing MFP of the same type, for example, can be used. In general, the image processing apparatus 200 performs transfer in a state in which the program is stored in the ROM 142 or the auxiliary storage device 144. However, a program and a piece of hardware in which the program is not stored or a separate version of the same type of program is stored may be separately transferred. In this case, the image processing apparatus 200 can be configured by writing the program in the auxiliary storage device 144 in response to an operator's operation. Note that a program may be transferred by being recorded on a removable storage medium such as a magnetic disk, a magnetooptical disk, an optical disk, a semiconductor memory, or through network-based communication.

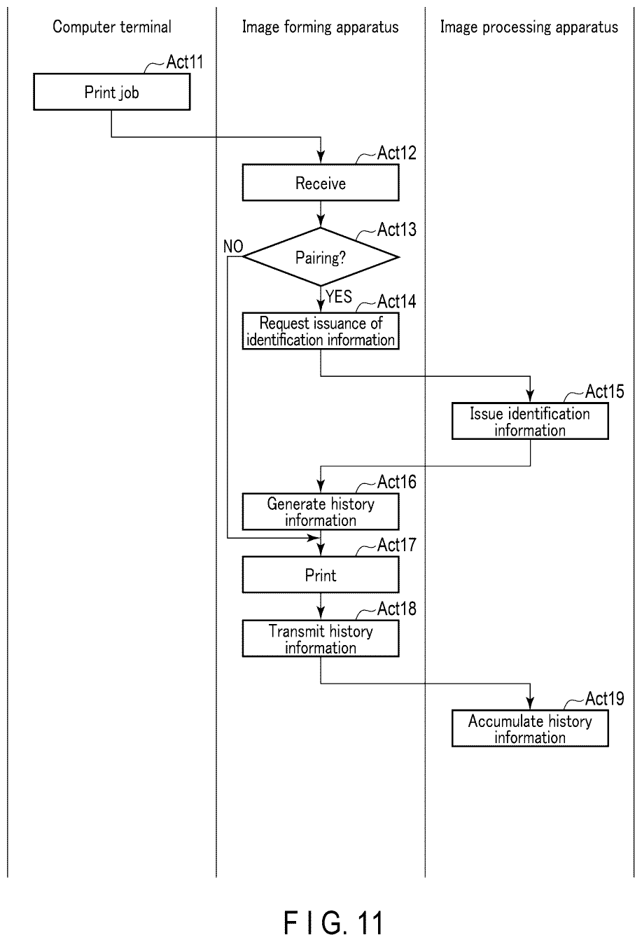

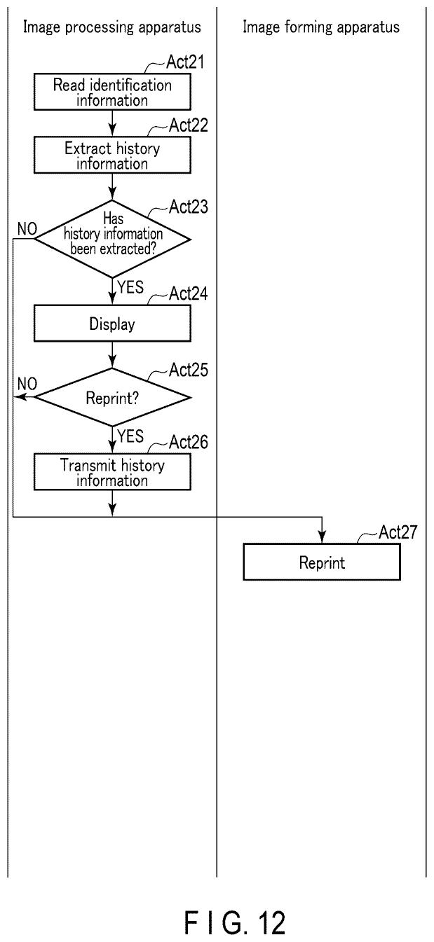

Next, an operation example of the above-described image processing system 100 will be described with reference to FIGS. 11 and 12.

As shown in FIG. 11, for example, if a print job is input from a computer terminal (Act11), the image forming apparatus 10 receives the print job with the communication interface 8 (Act12). Alternatively, the image forming apparatus 10 may receive an input of a print job by an operator via the operation section 17 (Act12).

If the image processing system 100 is in a mode of pairing the image forming apparatus 10 with the image processing apparatus 200 (Act13; YES), the image forming apparatus 10 that has received the print job outputs a request signal requesting issuance of label identification information via the request generator 4, and transmits the request signal to the image processing apparatus 200 via the communication interface 8 together with apparatus identification information of the image forming apparatus 10 (Act14).

Upon receiving the request signal from the image forming apparatus 10 via the communication interface 151, the image processing apparatus 200 issues identification information of a label on which the image forming apparatus 10 is to print an image at the issuance unit 154 (Act15). The image processing apparatus 200 returns the issued label identification information to the image forming apparatus 10 that has transmitted the request signal via the communication interface 151.

The image forming apparatus 10 that has received the label identification information issued by the image processing apparatus 200 generates, at the generator 2, history information containing the label identification information (Act16). The history information contains the print job received at Act12, and the print job contains printed data, a date and time of printing, a number of copies printed, etc.

The image forming apparatus 10 prints an image based on the print job on the label under the control of the print controller 68 (Act17). The image to be printed on the label includes a QR code, which is the label identification information (FIG. 10). Every time an image is printed on a label, the image forming apparatus 10 transmits history information related to the printing of the image to the image processing apparatus 200 via the communication interface 8 (Act18).

The image processing apparatus 200 stores and accumulates the history information received from the image forming apparatus 10 into the nonvolatile memory 57 (Act19). The management unit 152 manages the history information for each image forming apparatus based on the apparatus identification information. The management information managed by the management unit 152 may be printed on a paper sheet P at a given timing, or may be displayed via the operation panel 103.

If the image processing system 100 is not in a paring mode (Act13; NO), the image forming apparatus 10 that has received the print job shifts to Act17 without transmitting a request signal to the image processing apparatus 200 as in Act14, and prints an image based on the print job on a label. In this case, the history information of the image to be printed may not contain label identification information, or may contain label identification information issued by the image forming apparatus 10.

According to the operation example shown in FIG. 11, it is possible to manage a history of printing by the plurality of image forming apparatuses 10 with the image processing apparatus 200, and to print the management information onto a paper sheet P at a given timing, as described above. Note that the image processing apparatus 200 may be configured to print the same image as the image printed on a label on a paper sheet P, or to collectively print history information of each of the image forming apparatuses on a paper sheet P by identifying the apparatus-by-apparatus history information based on apparats identification information.

In the case where a label issued by the image forming apparatus 10 is reprinted, the image processing system 100 operates as shown in FIG. 12, for example.

First, the reader 155 of the image processing apparatus 200 scans the already issued label via the scanner 102, and reads identification information (a QR code) of the label from the scanned image (Act21). Thereafter, the processor 141 extracts history information corresponding to the label identification information read from the management information accumulated in the nonvolatile memory 57 at Act21 (Act22).

If the corresponding history information has been extracted at Act22 (Act23; YES), the processor 141 displays an image related to the history information extracted via the operation panel 103 at Act22 (Act24). The image displayed at Act24 includes, for example, a reprinting button for executing reprinting. If the corresponding history information cannot be extracted from the management information (Act23; NO), the processor 141 displays “No corresponding history information” via the operation panel 103, and ends processing.

If the reprinting button displayed at Act24 is input (Act25; YES), the communication interface 151 transmits the history information extracted at Act22 to the image forming apparatus 10 that has issued the label, together with a reprinting command (Act26). Alternatively, the communication interface 151 may be configured to transmit a print job contained in the history information extracted at Act22 to the image forming apparatus 10 specified with the apparatus identification information contained in the history information extracted at Act22.

Alternatively, the communication interface 151 may be configured to switch, via the operation panel 103, displaying of an image for accepting a change of the image forming apparatus 10 to which the history information is to be transmitted after an input has been made on the reprinting button, to change the image forming apparatus to which the history information is to be transmitted.

The image forming apparatus 10 that has received the history information and the reprinting command from the image processing apparatus 200 at Act26 prints (reprints) an image based on the history information on a label, under the control of the print controller 68 (Act27). Alternatively, the image forming apparatus 10 that has received a print job transmitted from the image processing apparatus 200 may be configured to print (reprint) an image based on the print job on a label, under the control of the print controller 68.

Note that a modification to the history information may be accepted in a state in which the image is being displayed at Act24.

According to the above-described operation example of FIG. 12, it is possible to reissue a label on which the same image as the image on an already issued label is printed simply by reading the already issued label with the scanner 102 of the image processing apparatus 200, without the burden of performing a complicated operation input for reprinting, thus enhancing convenience.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus, comprising:
a print controller configured to print an image based on a print job;
a generator configured to generate history information containing the print job and apparatus identification information; and
a communication interface configured to transmit the history information to an image processing apparatus.

2. The image forming apparatus according to claim 1, further comprising:
a request generator configured to output a request signal to request the image processing apparatus to issue label identification information.

3. The image forming apparatus according to claim 2, wherein
the communication interface transmits the request signal to the image processing apparatus, and receives the label identification information from the image processing apparatus.

4. The image forming apparatus according to claim 3, wherein
the print controller prints the label identification information and a target image.

5. The image forming apparatus according to claim 1, wherein
the history information contains information indicating that the print controller has performed printing.

6. The image forming apparatus according to claim 1, wherein
the history information contains image information related to the image printed by the print controller.

7. The image forming apparatus according to claim 6, wherein
the print controller prints the image on a label to be adhered to an article, and
the image information contains at least one of first image information related to the article to which the label is to be adhered and second image information related to delivery of the article.

8. The image forming apparatus according to claim 1, wherein
the history information contains information related to the print job.

9. The image forming apparatus according to claim 1, wherein
the history information contains a date and time of printing, and a number of copies printed.

10. An image processing apparatus, comprising:
a communication interface configured to receive, from an image forming apparatus, history information containing apparatus identification information and a print job executed by the image forming apparatus;
a management unit configured to manage the history information; and
an output unit configured to output the history information identified with the apparatus identification information.

11. The image processing apparatus according to claim 10, wherein
the output unit prints a plurality of items of the history information onto a paper sheet.

12. The image processing apparatus according to claim 10, further comprising:
an issuance unit configured to issue label identification information in response to an issuance request from the image forming apparatus.

13. The image processing apparatus according to claim 12, wherein
the communication interface returns the issued label identification information to the image forming apparatus that has made the issuance request.

14. The image processing apparatus according to claim 10, further comprising:
a reader configured to read an image printed by the image forming apparatus.

15. The image processing apparatus according to claim 14, further comprising:
an acquisition unit configured to acquire a request signal to reprint the image read by the reader.

16. The image processing apparatus according to claim 15, configured to:
extract the history information related to printing of the image in response to the request signal, and transmit the history information to the image forming apparatus.

17. The image processing apparatus according to claim 10, further comprising:
a reader, wherein
the communication interface is configured to receive, from a predetermined image forming apparatus, a request signal to request issuance of label identification information and containing the apparatus identification information, to transmit the label identification information to the predetermined image forming apparatus at which the label identification information and a target image is to be printed, and to receive the history information,
the management unit manages the history information corresponding to the transmitted label identification information,
the reader reads the label identification information printed by the predetermined image forming apparatus, and
the communication interface transmits, to the predetermined image forming apparatus, the print job to print the target image based on the history information corresponding to the read label identification information.

18. An image processing system, comprising an image forming apparatus and an image processing apparatus,
the image forming apparatus including: a print controller configured to print an image based on a print job; a generator configured to generate history information containing apparatus identification information and the print job; and a communication interface configured to transmit the history information to the image processing apparatus,
the image processing apparatus including: a communication interface configured to receive, from the image forming apparatus, the history information; a management unit configured to manage the history information; and an output unit configured to output the history information identified with the apparatus identification information.

19. The image processing system according to claim 18, wherein
the image forming apparatus includes a request generator configured to output a request signal to request the image processing apparatus to issue label identification information.

20. The image processing system according to claim 19, wherein
the image processing apparatus includes an issuance unit configured to issue the label identification information in response to the request signal generated by the request generator of the image forming apparatus.
